(19) United States
(12) Patent Application Publication
(10) Pub. No.: US 2020/0047199 A1
(43) Pub. Date: Feb. 13, 2020

(54) AQUEOUS PRODUCT APPLICATOR

(71) Applicant: Clayton Holznagel, Merrifield, MN (US)

(72) Inventor: Clayton Holznagel, Merrifield, MN (US)

(21) Appl. No.: 16/533,492

(22) Filed: Aug. 6, 2019

Related U.S. Application Data
(60) Provisional application No. 62/715,487, filed on Aug. 7, 2018.

(51) Int. Cl. B05B 7/14; A01G 20/47; B05B 7/24

(52) U.S. Cl. CPC B05B 7/1413; B05B 7/2402; A01G 20/47

(57) ABSTRACT

An aqueous product applicator that is connectable as an accessory retrofit product to a commercial or conventional home-use yard blower to convert to blower into an aqueous spraying device, the applicator including a fluid distribution head with an input port that is connectable to a source of pressurized aqueous solution, and a plurality of outlet ports designed to dispense fluid exiting the distribution head in the form of aqueous droplets. The distribution head further includes a mounting system for securing the distribution head to the mouth of the blower tube of a conventional handheld yard blower such that, during use, the aqueous droplets from the distribution head enter the jet air stream emitted by the blower for dispersion.

### CROSS REFERENCE TO RELATED APPLICATIONS

This application is a nonprovisional application which claims the benefit of U.S. Provisional Patent Application Ser. No. 62/715487, filed on Aug. 7, 2018, the contents of which is incorporated herein in its entirety by reference thereto.

### FIELD OF INVENTION

The present invention relates generally to the field of fluid applicators, and more particularly to an apparatus for injecting an aqueous solution into a jet stream for purposes of enhancing the broadcast of the aqueous solution in the form of a penetrating mist. Even more specifically, the present invention pertains to an aqueous solution delivery device in the form of an accessory attachment to an outdoor yard blower, or the like, which converts the blower apparatus into an effective aqueous product applicator.

### BACKGROUND

The statements in this section merely provide background information related to the present disclosure and may not constitute prior art.

There are many products currently available in the market for applying a fluid or aqueous solution, such as a pesticide, insecticide, herbicide and/or cleaning solution, to a desired object(s). Typically, most commercial grade devices and more formidable home devices are engine driven, back pack liquid sprayers that require oil and gas to operate. While these devices are effective, the operation of such devices, particularly during times of dry outdoor conditions, can significantly increase the potential for hazard caused by sparks and fire. Moreover, such devices take up valuable storage space, require constant maintenance and are extremely loud.

Indeed, powered sprayers of this type with gas driven engines typically produce 80-100 decibels when operating. If the correct hearing protection is not worn, long-term operation at this level is known to significantly increase the risk for hearing loss and noise fatigue to the operator. The National Institute for Occupational Safety and Health (NIOSH) has recommended that all worker exposure to noise should be controlled below a level equivalent to 85 DBA for eight hours to minimize occupational noise induced hearing loss. Also, certain Homer Owner Associations (HOA) are now restricting gas powered leaf blowers because of noise levels, thus preventing lawn care companies from providing service to HOA's or requiring start times to be rescheduled.

Storage space and maintenance can also pose difficult problems for conventional power sprayers. Such gas driven back pack sprayers of this type are usually specifically dedicated pieces of equipment which serve only one function, and are typically quite bulky and heavy to handle. Also, most are 2 cycle gas driven engines which require a gas and oil mixture to operate. Thus, they are expensive to operate, particularly in relation to battery powered equipment, such as battery powered leaf blowers. Oftentimes, multiple sprayers are employed to avoid potential mixing of aqueous solutions, requiring yet additional storage space and more overall maintenance to ensure continued efficient operation of the equipment. Consequently, conventional sprayers of this type can be quite cumbersome to use, and are not very versatile.

Yet another problem with conventional powered sprayers is that they are typically designed to discharge only a topical mist of an aqueous solution stored in a reservoir. This is of particular concern in an agricultural environment, as the mist emitted from such sprayers generally lands on and attaches only to the top of the vegetation. Unless the user of the spraying device manually moves the sprayer wand deeper within the vegetation, the spray normally fails to adequately coat the underside of the vegetation, and does not reach the ground cover where insects and noxious weeds thrive.

It is therefore evident that there is a significant need for a more versatile and efficient system for applying aqueous solution products, particularly in the agricultural and pest control industries, where powered liquid sprayers are commonly used to apply pesticides, insecticides and/or herbicides to existing vegetation. Ideally, such an aqueous product applicator should be of relatively small compass and compact for storage, and function as a retrofit item capable of use with existing outdoor handheld blower equipment. This not only avoids the need to store and maintain separate designated spraying equipment, but will also facilitate the use of much quieter existing, environmentally noise friendly blower equipment that can more efficiently broadcast and penetrate existing vegetation with the aqueous solution.

### SUMMARY

In furtherance of the foregoing objectives, the present invention is comprised generally of an aqueous product applicator that is connectable as an accessory retrofit product to the output blower tube or nozzle of a commercial or conventional home-use yard or leaf blower. The applicator includes a fluid distribution head with an input port that is connectable to a pressurized source of aqueous solution, and a plurality of outlet ports designed to dispense fluid exiting the distribution head in the form of aqueous droplets. The distribution head further includes a mounting system for securing the distribution head to the mouth of the blower tube of a conventional yard blower such that, during use, the aqueous droplets from the distribution head enter the jet air stream emitted by the blower for dispersion.

The source of aqueous solution may include a relatively compact pressurized fluid storage tank or reservoir that is connectable to the input port of the distribution head via a quick connect/disconnect fluid conveyance hose. The fluid storage tank is preferably constructed of relatively small compass and capable of being carried within a backpack worn by a user of the aqueous product applicator. The fluid storage tank may be pressurized for delivery of the aqueous solution to the distribution head via the use of either a manual hand pump or a battery powered electric pump. A shut off/flow control valve may be positioned at the input port of the distribution head for connection to the fluid conveyance hose, such that the rate of supply of incoming fluid to the distribution head may be controlled, as desired.

The plurality of outlet ports to the distribution head is located on a front end surface of the distribution head. The mounting system for the distribution head is also located proximate the front end of the distribution head, so as to facilitate alignment of the outlet dispensing ports with the mouth of the blower tube to which it is attached. The mounting system for the distribution head may incorporate one of more mounting forks, tongues, or the like, affixed adjacent the front bottom end of the distribution head, and extending rearward therefrom along a bottom surface of the distribution head. The fork(s) may be spaced slightly from the body of the distribution head, so as to form a guide channel capable of receiving the wall of the blower tube upon which it is to be installed. The terminal ends of the fork(s) may be tapered to help guide insertion of the blower tube wall into the channel formed by the mounting fork(s).

The aqueous product applicator may be retrofitted to any conventional commercial or home-use gas or electric yard blower unit by simply attaching the distribution head to the mouth of the blower tube. The distribution head is designed to be mounted atop of the blower tube, with a portion of the upper wall section of the tube inserted within the guide channel formed by the mounting fork(s). A pair of set screws extending through the body of the distribution head may be used to lock the distribution head in place on the blower tube during use. Upon tightening the set screws, the upper wall section of the blower tube is pressed against the mounting fork(s) so as to securely lock the distribution head in place with the outlet ports overhanging the front of the of the blower tube. Preferably, the set screws are in the form of a pair of wing nuts to permit the aqueous product applicator to be easily attached and detached by hand, without the need for extra tools.

With my aqueous product applicator, fluid carried by the user in a compact storage container is fed through the distribution head and allowed to drip at a controlled rate of dispersion out the outlet ports and into the jet airstream of any commercial grade or home-use yard blower. By introducing the aqueous solution into a jet airstream, a powerful liquid mist is produced that can more effectively penetrate the desired areas of application. In agricultural applications, particularly for mosquito and tick control, the liquid air-blown product acts to agitate and churn the foliage so as to better penetrate and coat the underside of the foliage.

With the rise of vector borne diseases, my aqueous product applicator can be utilized on a commercial scale, and/or is easily adaptable for homeowner use as well. With its portable and versatile use, it can quickly be removed from any gas engine yard blower, which creates noise levels readings in excess of 85 decibels, and inserted into a quieter AC or lithium battery powered electric yard blower.

My aqueous product applicator can therefore be used as a versatile retrofit assembly device with multiple different aqueous solutions, storage containers and/or blowers, thus eliminating the need to purchase, store and maintain multiple noisy, job-specific, gas-powered commercial grade liquid spraying devices. My aqueous product applicator facilitates economical and efficient conversion of an existing yard blower to a powerful, more quite aqueous spraying device that can more effectively broadcast and penetrate existing vegetation with a desired aqueous solution.

The foregoing and additional features and advantages of the present invention will be more readily apparent from the following detailed description. It should be understood, however, that the description and specific examples herein are intended for purposes of illustration only and are not intended to limit the scope of the present disclosure.

### DRAWINGS

The drawings described herein are for illustration purposes only and are not intended to limit the scope of the present disclosure in any way.

FIG. 1 is a diagrammatic representation of the present invention, comprising an aqueous product applicator which includes a fluid distribution head that may be added to a conventional handheld yard blower as an accessory retrofit product to convert the blower into an effective aqueous sprayer;

FIG. 2 is a perspective view showing one exemplary embodiment of the present invention with the fluid distribution head mounted to the output of the blower tube of the yard blower and a back pack unit for carrying a storage tank of aqueous solution;

FIG. 3 is a close-up perspective view of the fluid distribution head of my aqueous product applicator mounted to the output end of a blower tube in a manner to allow droplets of aqueous solution exiting the distribution head to enter the jet airstream of the blower to which it is attached;

FIG. 4 is a close-up perspective view showing the front end of the distribution head of my aqueous product applicator attached to the output end of a blower tube; and

FIG. 5 is a close-up perspective view showing the mounting system carried on the underside of the distribution head of my aqueous product applicator, which is used to mount the distribution head upon the output end of a blower tube of a handheld yard blower.

### DETAILED DESCRIPTION

The following description is merely exemplary in nature and is not intended to limit the present disclosure, application, or uses. It should be understood that throughout the drawings, corresponding reference numerals indicate like or corresponding parts and features.

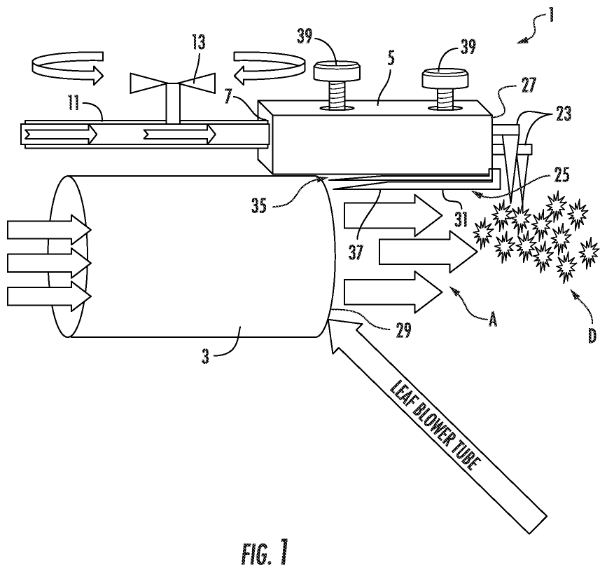

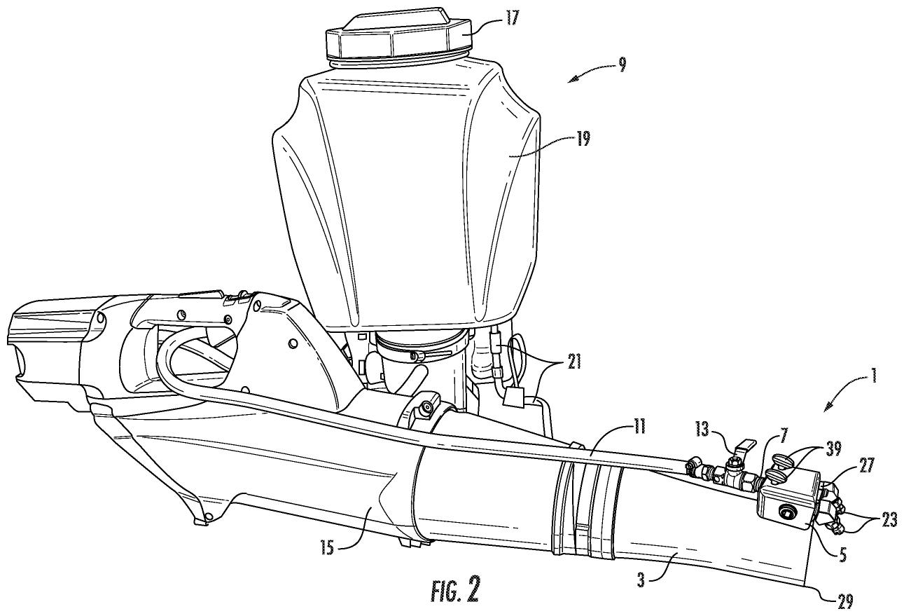

With reference now to the drawings, and particularly to FIGS. 1 and 2, an aqueous product applicator 1 is shown constructed in accordance with my invention. As illustrated, the aqueous product applicator 1 is connectable as an accessory retrofit product to the output blower tube or nozzle 3 of a conventional handheld commercial or home-use yard blower 15. The aqueous product applicator 1 includes a fluid distribution head 5, the main valve body of which may be constructed of aluminum, stainless steel or other suitable rigid material. The distribution head 5 has a fluid input port 7 that is connectable to a pressurized source of aqueous solution 9 via a fluid conveyance hose 11. A shut off/flow control valve 13 may be positioned at the input port 7 of the distribution head 5 for connection to the fluid conveyance hose 11, such that the rate of supply of incoming fluid to the distribution head 5 may be controlled, as desired. The conveyance hose 11 may be equipped with an optional quick connect/disconnect fitting (not shown) on one or both ends to facilitate ease and versatility in use with different aqueous storage containers.

As shown in FIG. 2, the source of aqueous solution 9 may include a compact pressurized fluid storage tank or reservoir 19 having a top opening with a removable cover 17 to allow the tank to be filled and refilled, as necessary. Preferably, storage tank 19 is constructed of relatively small compass and capable of being carried as part of a backpack 21 worn by a user of the aqueous product applicator 1. The fluid storage tank 19 may be constructed of a chemical resistant polyethylene material, and may include a manual hand pump or battery powered electric pump (not shown) to generate pressure for delivery of the aqueous solution to the distribution head 5. In one embodiment, as shown, it is contemplated that the back pack unit 21 may be comprised of an aluminum tubular frame upon which the storage tank 19 is mounted, and may include cushioned shoulder straps for comfort.

As seen in FIGS. 1 and 2, the distribution head 5 of the aqueous product applicator 1 includes a plurality of outlet ports 23 which are designed to dispense fluid exiting the distribution head 5 in the form of aqueous droplets (D). By controlling the rate of flow of incoming aqueous solution to the distribution head 5 with the control valve 13, the rate of delivery of the droplets of aqueous solution at the output ports 23 can be effectively controlled. As will be described in more detail hereafter, the distribution head 5 further includes a mounting system 25 for securing the distribution head 5 to the mouth of the blower tube 3 such that, during use, the aqueous droplets (D) from the distribution head 5 enter the jet airstream (A) emitted by the blower 15 for dispersion (See, FIG. 1). The aqueous droplets (D) entering the jet airstream (A) of the blower are thus effectively converted into a powerful penetrating mist that may be effective for use in a broad array of different commercial or home-use applications.

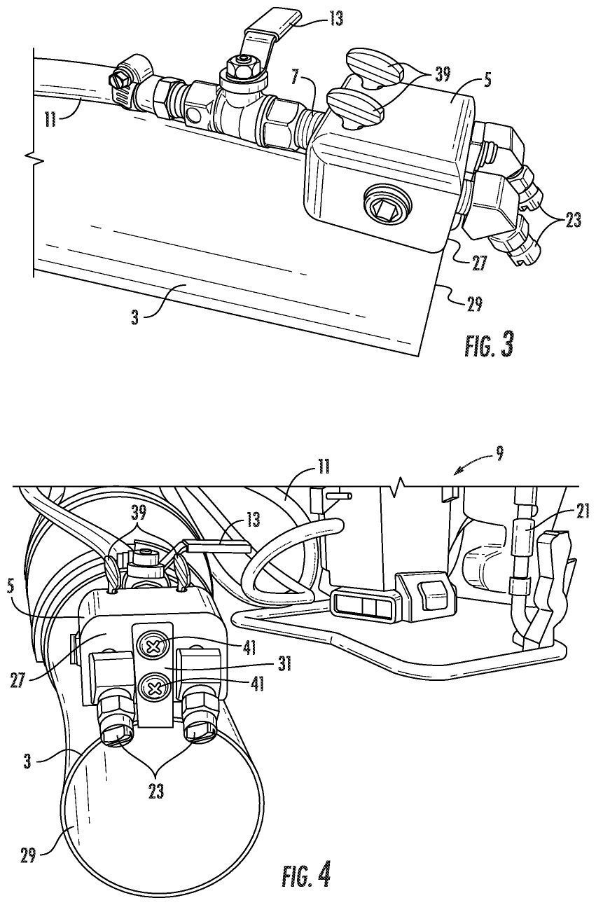

As shown best in FIGS. 2-4, to accomplish the forgoing, the plurality of outlet ports 23 to the distribution head 5 may be located on a front end surface 27 of the distribution head 5, opposite the input port 7 thereof. As illustrated in FIGS. 2-3, it is contemplated that the distribution head 5 may be removably mounted upon the top surface of blower tube 3, with the front face 27 thereof positioned at or near the front edge 29 of the blower tube. In this manner, the plurality of nozzles 23 will extend outward beyond the front edge 29 of the tube 3, such that the droplets of aqueous solution (D) exiting nozzles 23 will fall via gravity into the blowing jet airstream (A) of blower 15.

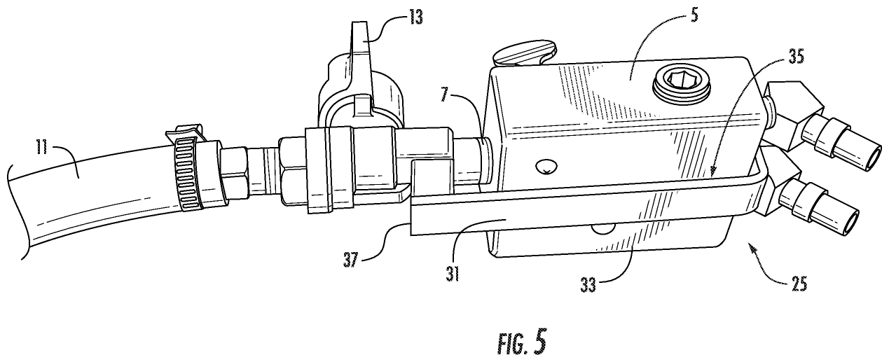

As seen best in FIGS. 1 and 5, the mounting system 25 for the distribution head 5 is also located proximate the front end 27 of the distribution head 5, so as to facilitate alignment of the outlet dispensing ports 23 with the mouth of the blower tube 29 to which it is attached. In one embodiment, it is contemplated that the mounting system 25 for the distribution head 5 may comprise one of more mounting forks, tongues, or the like 31 which extend slightly downward and rearward along the bottom surface 33 of the distribution head 5. As shown in FIG. 4, such fork(s) 31 may be affixed to the front end surface 27 of the distribution head 5 via a set of screws 41. As best seen in FIG. 5, the fork(s) 31 then bend around the bottom front edge of the body of distribution head 5 and extend rearward along its bottom surface 33.

As seen in FIGS. 1 and 5, the fork(s) 31 are spaced slightly from the body of the distribution head 5, so as to form a guide channel 35 capable of receiving the wall of the blower tube 3 upon which it is to be installed. The terminal ends 37 of the fork(s) 31 may be tapered to help guide insertion of the blower tube wall into the channel 35 formed by the mounting fork(s) 31. As noted previously and shown in FIGS. 1-4, the distribution head 5 is intended to be mounted on the top of blower tube 3. Therefore, by inserting the upper wall portion of the blower tube 3 into the guide channel 35 formed by guide fork(s) 31, the front end 27 of the distribution head 5 may be closely aligned with the front edge 29 of the blower tube 3.

As shown best in FIG. 3, a pair of set screws 39 extending through the body of the distribution head 5 is designed to work in conjunction with the mounting forks(s) 31 to lock the distribution head 5 in place on the blower tube 3 during use. Upon tightening the set screws 39, the screws 39 will protrude through the bottom of the distribution head 5 and bear against the upper wall section of the blower tube 3. Consequently, the wall of the blower tube 3 becomes sandwiched between the set screws 39 and the mounting fork(s) 31 of distribution head 5, thereby securely locking the distribution head 5 in place upon the blower tube 3. With proper alignment of the front face 27 of the distribution head 5 with the front end 29 of the blower tube 3, the outlet ports 23 of the distribution head 5 will overhang the front of blower tube 3, as desired. Preferably, the set screws 39 are in the form of a pair of wing nuts to permit the aqueous product applicator 1 to be easily attached and detached by hand, without the need for extra tools.

As shown throughout the drawings, the distribution head 5 is designed to be mounted upon the top of the blower tube 3, such that the droplets of aqueous solution (D) emitted therefrom will drop into the path of the blower airstream (A). With my aqueous product applicator 1, fluid carried by the user in a compact storage container 19 may be fed through the distribution head 5 of the aqueous product applicator 1 and allowed to drip at a controlled rate of dispersion out the outlet ports 23 and into the jet airstream (A) of any commercial grade or home-use handheld yard blower unit 15. By introducing the aqueous solution into a jet airstream, a powerful liquid mist is produced that can more effectively penetrate the desired areas of application. In agricultural applications particularly, for mosquito and tick control, the liquid air-blown product acts to agitate and churn the foliage so as to better penetrate and coat the underside of the foliage.

With the rise of vector borne diseases, my aqueous product applicator 1 can be utilized on a commercial scale, and/or is easily adaptable for homeowner use as well. The aqueous product applicator 1 may be retrofitted to any conventional handheld commercial or home-use gas or electric yard blower unit 15 by simply attaching the distribution head 5 to the mouth of the blower tube 3. With its portable and versatile use, it can quickly be removed from any gas engine yard blower, which creates noise levels readings in excess of 85 decibels, and inserted into a quieter AC or lithium battery powered electric yard blower.

As noted previously, my aqueous product applicator 1 can therefore be used as a versatile retrofit assembly device with multiple different aqueous solutions, storage containers and/or blowers, thus eliminating the need to purchase, store and maintain multiple noisy, job-specific, gas-powered commercial grade liquid spraying devices. My aqueous product applicator facilitates economical and efficient conversion of an existing yard blower to a powerful, more quite aqueous spraying device that can more effectively broadcast and penetrate existing vegetation with a desired aqueous solution.

The disclosure herein is intended to be merely exemplary in nature and, thus, variations that do not depart from the gist of the disclosure are intended to be within the scope of the disclosure. Such variations are not to be regarded as a departure from the spirit and scope of the disclosure, which comprises the matter shown and described herein, and set forth in the appended claims.

1. A retrofit aqueous product applicator for connection to the output of a powered air blower to provide controlled dispersion of a fluid into the output airstream of the blower, comprising:
(a) a source of pressurized fluid;
(b) a distribution head fluidly connected to said source of pressurized fluid;
(c) a flow control valve connected to said distribution head, said flow control valve being adjustable to control the level of output of said fluid to said distribution head; and
(d) a releasable mounting member attached to said distribution head, said mounting member being constructed to be releasably secure to the output of the powered air blower to position said distribution head for controlled dispersion of a measured amount of said fluid into the output airstream of the blower.

2. The retrofit aqueous product applicator of claim 1, wherein said distribution head includes a plurality of output nozzles for distributing said fluid therefrom into the airstream of the blower.

3. The retrofit aqueous product applicator of claim 1, wherein said flow control valve is manually operable and adjustable to control the amount of said fluid that is dispersed by said distribution head into the airstream of the blower.

4. The retrofit aqueous product applicator of claim 1, wherein said flow control valve is connected in line with a fluid distribution tube which connects said source of pressurized fluid to said distribution head.

5. The retrofit aqueous product applicator of claim 1, wherein said releasable mounting member is comprised of a clamping mechanism that is disposed on an underside portion of said distribution head.

6. The retrofit aqueous product applicator of claim 5, wherein said clamping mechanism includes at least one fork which extends underneath said distribution head in slightly spaced relation thereto, thereby forming a guide channel for receipt of the blower output.

7. The retrofit aqueous product applicator of claim 6, wherein said releasable mounting member includes at least one adjustable set screw disposed in clamping relation with said fork to provide adjustability in the tightness of said distribution head on the output of the blower.

8. A retrofit aqueous product applicator for use in connection with a powered air blower to provide controlled dispersion of a fluid into the output airstream of the blower, comprising:
(a) a powered air blower having an output discharge tube through which an airstream jet is expelled;
(b) a source of pressurized fluid;
(c) a distribution head fluidly connected to said source of pressurized fluid, said distribution head being mounted in readily releasable relation upon an upper surface of said discharge tube adjacent a terminal end of said tube where said airstream jet is expelled; and
(d) a flow control valve connected to said distribution head, said flow control valve being adjustable to control the level of output of said fluid to said distribution head.

9. The retrofit aqueous product applicator of claim 8, wherein said distribution head is positioned on said discharge tube so as to provide controlled dispersion of a measured amount of said fluid into said airstream jet of said powered air blower.

10. The retrofit aqueous product applicator of claim 8, wherein said distribution head includes a plurality of output nozzles for distributing said fluid therefrom into said airstream jet of said blower.

11. The retrofit aqueous product applicator of claim 10, wherein said nozzles extend slightly outward over said terminal end of said discharge tube of said blower.

12. The retrofit aqueous product applicator of claim 8, wherein said flow control valve is manually operable and adjustable to control the amount of said fluid that is dispersed by said distribution head into said airstream jet of said blower.

13. The retrofit aqueous product applicator of claim 8, wherein said flow control valve is connected in line with a fluid distribution tube which connects said source of pressurized fluid to said distribution head.

14. The retrofit aqueous product applicator of claim 8, including a releasable mounting member in the form of a clamping mechanism that is mounted upon said distribution head and disposed on an underside portion of said distribution head.

15. The retrofit aqueous product applicator of claim 14, wherein said clamping mechanism includes at least one fork which extends underneath said distribution head in slightly spaced relation thereto, thereby forming a guide channel for receipt of said terminal end of said discharge tube.

16. The retrofit aqueous product applicator of claim 15, wherein said releasable mounting member includes at least one adjustable set screw which extends through a portion of said distribution head in clamping relation with said fork to provide adjustability in the tightness of said distribution head on said discharge tube of said blower.

17. The retrofit aqueous product applicator of claim 8, wherein said source of pressurized fluid is selected from a group consisting of either a manual or electric pump apparatus.

18. A retrofit aqueous product applicator for use in connection with a powered air blower to provide controlled dispersion of a fluid into the output airstream of the blower, comprising:
(a) a powered air blower having an output discharge tube through which an airstream jet is expelled;
(b) a source of pressurized fluid;
(c) a distribution head fluidly connected to said source of pressurized fluid, said distribution head having a plurality of fluid output nozzles associated therewith;
(d) a flow control valve connected to said distribution head, said flow control valve being adjustable to control the level of output of said fluid to said distribution head; and
(e) a releasable mounting member attached to said distribution head, said mounting member being secured in readily releasably relation to an upper surface of said discharge tube adjacent a terminal end thereof, such that said nozzles of said distribution head extend slightly outward over said terminal end of said discharge tube.

19. The retrofit aqueous product applicator of claim 18, wherein said releasable mounting member is comprised of a clamping mechanism that is disposed on an underside portion of said distribution head.

20. The retrofit aqueous product applicator of claim 19, wherein said clamping mechanism includes at least one fork which extends underneath said distribution head in slightly spaced relation thereto, thereby forming a guide channel for receipt of said terminal end of said discharge tube.
